(19) United States
(12) Patent Application Publication
(10) Pub. No.: US 2009/0135592 A1
(43) Pub. Date: May 28, 2009

(54) LED PACKAGE, AND ILLUMINATION DEVICE AND LIQUID CRYSTAL DISPLAY DEVICE PROVIDED THEREWITH

(75) Inventor: Tetsuya HAMADA, Matsusaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/282,899

(22) PCT Filed: Nov. 6, 2006
(86) PCT No.: PCT/JP2006/322067

§ 371 Date: Sep. 15, 2008

(30) Foreign Application Priority Data
Apr. 10, 2006 (JP) 2006-107086

(51) Int. Cl. F21V 8/00; F21V 21/00

(52) U.S. Cl. 362/231; 349/84; 257/99

(57) ABSTRACT

In an LED package, LED chips are connected in parallel by wires between lead frames connected to terminals. When an open circuit failure such as the coming off of the wire occurs in one of the LED chips in the LED package that is being energized, a current twice as high as that flowing through the other LED chip prior to the open circuit failure is passed through the other LED chip, and thus the amount of light emitted therefrom is increased about two-fold. Consequently, the amount of light emitted from the LED package does not change significantly.

### BACKGROUND OF THE INVENTION

1. Field of the Invention

The present invention relates to an LED package, and an illumination device and a liquid crystal display device incorporating such an LED package.

2. Description of the Related Art

In recent years, products that incorporate, as a display device, a liquid crystal panel thinner than a CRT (cathode ray tube) have been widely used. Since the liquid crystal panel itself emits no light, it displays an image by the use of external light or light emitted from an illumination device.

One example of an illumination device for use in a liquid crystal display device is a sidelight backlight proposed in JP-A-2004-021147 (pages 4 and 5, FIG. 1). This illumination device is disposed at the back side of a liquid crystal panel. In the illumination device, on the side of a flat plate called a light guide plate formed of acrylic resin, LED (light emitting diode) packages are disposed as a light source; light from the LED packages reflects inside the light guide plate and emanates from its upper surface, that is, its emission surface, and the light is then shone on the liquid crystal panel.

Incidentally, in a case where a wire bonded to an LED chip is broken, and thus an open circuit failure or other failures occur and this causes the LED packages disposed on the side of the light guide plate to become unlit, variations in the brightness and color of light emanating from the emission surface occur. Such variations in the brightness and color of backlight affect the display of the liquid crystal panel, with the result that the display quality of the liquid crystal display device is degraded.

### SUMMARY OF THE INVENTION

In order to overcome the problems described above, preferred embodiments of the present invention provide an LED package that can maintain its lit state and can maintain the amount of light emitted even when an open circuit failure occurs in an LED chip, and provide an illumination device for use in a liquid crystal display device in which variations in the brightness and color of light emitted are less likely to occur even when an open circuit failure occurs in an LED package.

According to a preferred embodiment of the present invention, an LED package includes a light emission section having two terminals and a plurality of LED chips connected to the terminals. The plurality of LED chips are connected in parallel between the terminals.

According to another preferred embodiment of the present invention, an illumination device includes: a light source section having a plurality of LED packages configured as described above and connected in series; and a light guide plate transmitting light emitted from the light source section and radiating the light from the emission surface thereof.

According to another preferred embodiment of the present invention, a liquid crystal display device includes a liquid crystal panel and the illumination device configured as described above and arranged to emit, from the back of the liquid crystal panel, the light radiated from the emission surface of the light guide plate.

According to a preferred embodiment of the present invention, since a plurality of LED chips are connected in parallel between terminals, even when an open circuit failure occurs in any of the LED chips, an LED package can maintain its lit state as long as there is an LED chip having no open circuit failure. The current flowing through the LED chip having an open circuit failure is passed through the other LED chip, and thus the amount of light emitted by the other LED chip is increased, with the result that the amount of light emitted from the entire LED package does not significantly vary before and after the open circuit failure occurs.

According to another preferred embodiment of the present invention, a plurality of light emission sections are provided, and thus LED chips emitting different color light can be provided in the light emission sections. This allows the LED package to emit different color light including white light.

According to another preferred embodiment of the present invention, LED chip groups of LED chips connected in parallel are connected in series between terminals, and thus a larger number of chips can be provided in the LED package.

According to another preferred embodiment of the present invention, a plurality of LED chips whose forward voltages Vf fall within the same grade are used, and thus substantially the same amount of current can be passed through the LED chips connected in parallel. This results in reduced variations in the amount of light emitted by the LED chips and in the life of the LED chips. Thus, it is possible to achieve stable light emission from the entire LED package.

According to another preferred embodiment of the present invention, a light emission section including LED chips emitting red light, a light emission section including LED chips emitting green light and a light emission section including LED chips emitting blue light are provided, and thus the LED package emitting whit light can be obtained. Hence, it is possible to improve the durability of the LED package as compared with an LED package that emits white light by the use of LEDs of the same color and fluorescent material.

According to preferred embodiment of the present invention, a larger number of the green LED chips are provided than each of the red and blue LED chips. Thus, it is possible to increase the brightness of green light without passing a high current through the green LED chips having lower brightness than the red and blue LED chips. This allows easier adjustment of the balance (white balance) of white light emitted and results in improved durability of the green LED chips.

According to another preferred embodiment of the present invention, the LED packages connected in series are provided in the light source section of an illumination device, and thus the amount of light emitted from the light source section is substantially maintained even when an open circuit failure occurs in any of the LED packages, with the result that the amount of light emanating from the light guide plate remains substantially unchanged, and little variation in brightness and colors occurs.

According to another preferred embodiment of the present invention, the illumination device is provided in a liquid crystal panel, and thus the amount of light emitted from the illumination device remains unchanged even when an open circuit failure occurs in any of the LED packages. Thus, it is possible to achieve stable display of a liquid crystal display device.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram schematically showing the configuration of a liquid crystal display device according to a first preferred embodiment of the present invention.

FIG. 2 is a plan view of a backlight according to the first preferred embodiment of the present invention.

FIG. 3 is a front view of the backlight according to the first preferred embodiment of the present invention.

FIG. 4 is a diagram schematically showing the configuration of an LED package according to the first preferred embodiment of the present invention.

FIG. 5 is a circuit diagram showing currents flowing through a light source section according to the first preferred embodiment when it is in normal condition.

FIG. 6 is a circuit diagram showing currents flowing through the light source section according to the first preferred embodiment when an open circuit failure occurs.

FIG. 7 is a diagram schematically showing the configuration of an LED package according to a second preferred embodiment of the present invention.

FIG. 8 is a diagram schematically showing the configuration of an LED package according to a third preferred embodiment of the present invention.

FIG. 9 is a front view of a light source section according to the third preferred embodiment of the present invention.

FIG. 10 is a diagram schematically showing the configuration of an LED package according to another aspect of the third preferred embodiment of the present invention.

FIG. 11 is a diagram schematically showing the configuration of an LED package according to another aspect of the third preferred embodiment of the present invention.

### DETAILED DESCRIPTION OF THE PREFERRED EMBODIMENTS

### First Preferred Embodiment

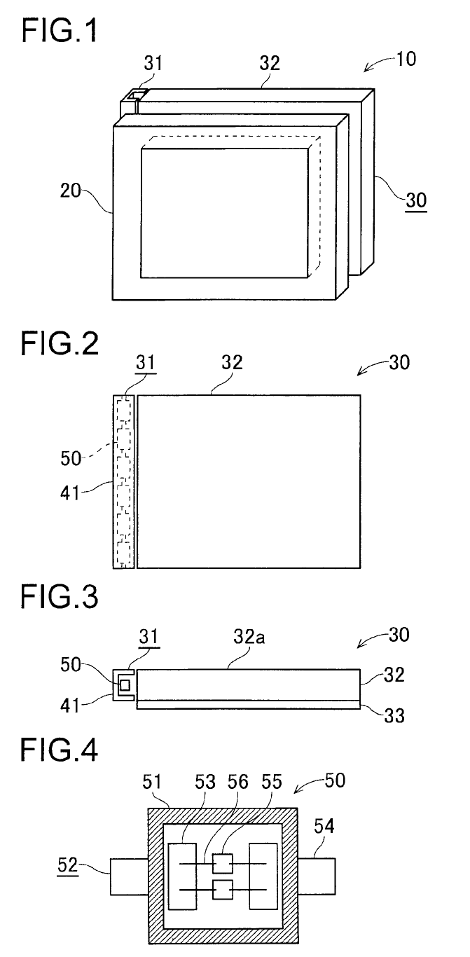

A first preferred embodiment of the present invention will be described with reference to the accompanying drawings. FIG. 1 is a diagram schematically showing the configuration of a liquid crystal display device according to the first preferred embodiment. FIG. 2 is a plan view of a backlight according to the first preferred embodiment. FIG. 3 is a front view of the backlight according to the first preferred embodiment. FIG. 4 is a diagram schematically showing the configuration of an LED package according to the first preferred embodiment.

As shown in FIG. 1, the liquid crystal display device 10 has a liquid crystal panel 20 and the backlight 30 serving as an illumination device. The liquid crystal panel 20 has a TFT substrate, an opposite substrate and liquid crystal sealed in therebetween. The orientation of the liquid crystal is controlled by applying voltage to both the substrates, and this allows an image to be displayed. The backlight 30 is disposed on the back of the liquid crystal panel 20 and shines white light emitted from its emission surface on the liquid crystal panel 20 to display an image.

As shown in FIGS. 2 and 3, the backlight 30 has a light source section 31, a light guide plate 32 and a reflective plate 33. The light source section 31 has a reflector 41 and LED packages 50 disposed inside the reflector 41. The light source section 31 is arranged such that light emitted from the LED packages 50 enters the light guide plate 32 through its side surface. The reflective plate 33 is disposed so as to face the side of the light guide plate 32 opposite to the side facing the liquid crystal panel 20.

Light emitted from LED chips 55 disposed inside the LED packages 50 in the light source section 31 enters the light guide plate 32 through its side surface, either directly or by reflection from the inner surface of the reflector 41. Then, the light travels through the inside of the light guide plate 32, and emanates as white light from the emission surface 32a opposite the liquid crystal panel 20. Light directed from the light guide plate 32 to the reflective plate 33 is reflected by the reflective plate 33 back to the light guide plate 32, and travels through the inside of the light guide plate 32.

In this preferred embodiment, as shown in FIG. 4, the LED package 50 has a frame 51 formed of white resin (the frame 51 is filled with transparent resin) and a light emission section 52. In FIG. 4, the frame 51 is shown in cross section, and the other components are also shown in cross section. The light emission section 52 has two lead frames 53, terminals 54 connected to the lead frames 53 and two LED chips 55. Inside the frame 51, each LED chip 55 is individually connected to both the lead frames 53 by wires 56. The wires 56 are bonding wires, and bonding wires formed of, for example, gold may be used. The terminals 54 disposed outside the frame 51 are used to connect to a power supply (unillustrated) and adjacent LED packages 50. The LED packages 50 are connected in series by the terminals 54 and are disposed inside the reflector 41.

With this configuration, even when an open circuit failure occurs, such as by the disconnection of the wire 56 connected to one of the two LED chips 55 while the LED package 50 is energized, the other LED chip 55 remains energized. Thus, the LED package 50 does not cease emitting light.

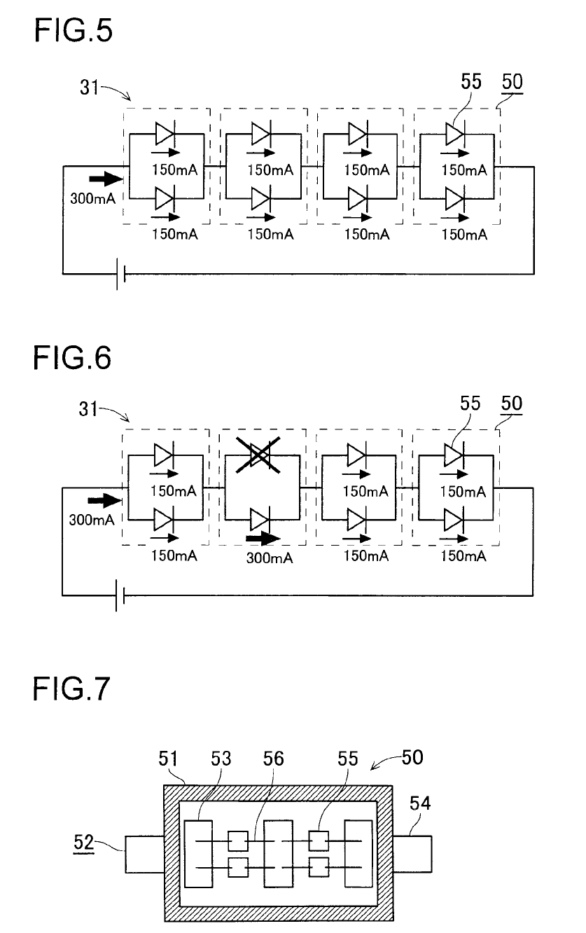

A detailed description will now be given of the condition when an open circuit failure occurs. FIGS. 5 and 6 are circuit diagrams of the light source section 31. In a case where the light source section 31 is configured as described above and the LED chips 55 are the same as each other, when a current of, for example, 300 mA is passed through the light source section 31, a current of 150 mA is passed through each LED chip 55 when they are in normal condition as shown in FIG. 5. In contrast, in a case where one of the LED chips 55 in one of the LED packages 50 has an open circuit failure as shown in FIG. 6, a current of 300 mA is passed through the other LED chip 55. The amount of light emitted by the LED chip 55 through which a current of 300 mA is passed is substantially twice the amount of light emitted by the LED chip 55 through which a current of 150 mA is passed. Thus, the amount of light emitted by the LED package 50 remains substantially unchanged before and after the open circuit failure occurs. Hence, the amount of light emanating from the light guide plate 32 remains substantially unchanged. This makes it possible to achieve stable display of the liquid crystal display device 10.

### Second Preferred Embodiment

A second preferred embodiment of the present invention will be described with reference to the accompanying drawings. FIG. 7 is a diagram schematically showing the configuration of an LED package according to the second preferred embodiment. The second preferred embodiment is the same as the first preferred embodiment except that the configuration of the light emission section is different from each other, and such parts as are substantially the same as each other are identified with common reference numerals.

As shown in FIG. 7, the LED package 50 of this preferred embodiment has a frame 51 and a light emission section 52. The light emission section 52 has three lead frames 53, two disposed at both ends of the frame 51 and the other disposed in the middle thereof inside the frame 51, terminals 54 connected to the lead frames 53 at both ends and four LED chips 55. Between the lead frames 53 at both ends and the lead frame 53 in the middle, two LED chips 55 are individually connected in parallel by wires 56. That is, two LED chip groups of two LED chips 55 connected in parallel are connected in series between the two terminals 54.

With this configuration, even when an open circuit failure occurs in one of the LED chips 55, which are connected in parallel in the LED package 50, in one of the LED chip groups, the other LED chip 55 remains energized, and thus the amount of light emitted by the LED package 50 remains substantially unchanged. Moreover, since a larger number of LED chips 55 can be housed in the LED package 50, a larger amount of light emitted can be obtained with respect to the size of the LED package 50 as compared with the first preferred embodiment.

In the second preferred embodiment, three or more LED chip groups of two LED chips 55 connected in parallel may be connected in series.

In the first and second preferred embodiments, LED packages 50 emitting white light may be provided or LED packages 50 emitting red (R), green (G) and blue (B) light may be provided in appropriate combination in the light source section 31 because the aim here is to emit white light from the backlight 30. Three or more LED chips 55 connected in parallel may be used. Preferably, the LED chips 55 are the same as each other. More preferably, their forward voltages Vf fall within the same grade. Forward voltages Vf of the same grade mean that when, for example, the same amount of current is passed through the LED chips 55, a voltage difference therebetween is 0.3 volts or less. In this case, the voltage range of the grade is 0.3 volts. The use of the LED chips whose forward voltages Vf fall within the same grade allows substantially the same amount of current to be passed through the LED chips 55. Thus, it is possible to reduce variations in the amount of light emitted by the LED chips 55 and in the life of the LED chips 55. Hence, the LED packages 50 can produce stable light emission.

### Third Preferred Embodiment

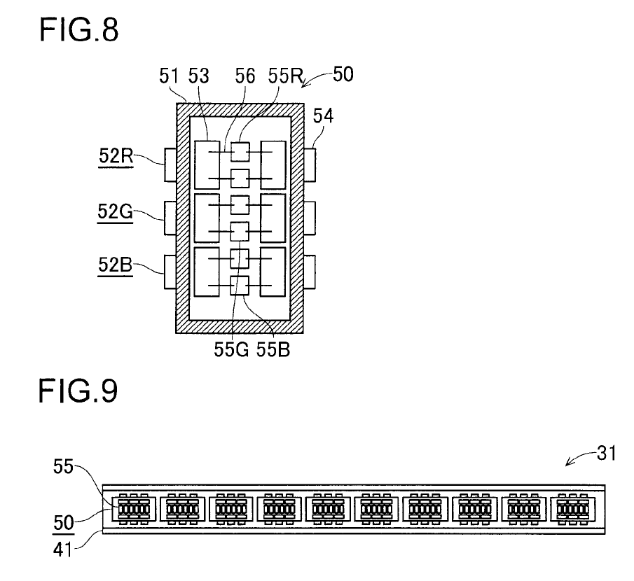

A third preferred embodiment of the present invention will be described with reference to the accompanying drawings. FIG. 8 is a diagram schematically showing the configuration of an LED package according to the third preferred embodiment. The third preferred embodiment is the same as the second preferred embodiment except that the LED package 50 has three light emission sections, and the three light emission sections have LED chips emitting red (R), green (G) and blue (B) light, respectively and such parts as are substantially the same as each other are identified with common reference numerals.

As shown in FIG. 8, the LED package 50 of this preferred embodiment has a frame 51 and the three light emission sections 52R, 52G and 52B. Each of the light emission sections 52R, 52G and 52B has two lead frames 53, terminals 54 connected to the lead frames 53 and two LED chips emitting red (R), green (G) or blue (B) light.

In the light emission sections 52R, 52G and 52B, the LED chips 55R, 55G and 55B are individually connected to both the lead frames 53 by wires 56 inside the frame 51. The brightness and emission colors of the LED chips 55R, 55G and 55B of the individual colors are selected so that when all the LED chips 55R, 55G and 55B emit light simultaneously, the LED package 50 emit desired white light. Preferably, the LED chips 55R, 55G and 55B of the individual colors are aligned as shown in FIG. 8 so that the width of the LED package 50 is reduced and thus compactness is achieved.

Inside a reflector 41 in a light source section 31, adjacent LED packages 50 are coupled by connecting the terminals 54 of the light emission sections 52R, 52G and 52B of the same color, either directly or by wires.

With this configuration, even when an open circuit failure occurs in one of the LED chips in one of the light emission sections 52R, 52G and 52B, the other LED chip remains energized. Thus, the LED package 50 does not cease emitting light. Unlike a while LED where LED chips of the same color are only included and white light is emitted by the action of fluorescent material coated on a frame, the LED package 50 uses no fluorescent material of low durability. Thus, it is possible to improve durability.

As shown in a front view of the light source section 31 of FIG. 9, the LED packages 50 are arranged in the same direction as that in which the LED chips 55R, 55G and 55B are disposed inside the reflector 41. Thus, it is possible to reduce the height of the light source section 31. Hence, even when a thin light guide plate 32 is used, the LED chips 55R, 55G and 55B in the LED packages can be disposed opposite the side of the light guide plate 32. This makes it possible not only to improve the use efficiency of light emitted from the LED packages 50 but also to reduce the thickness of the backlight 30.

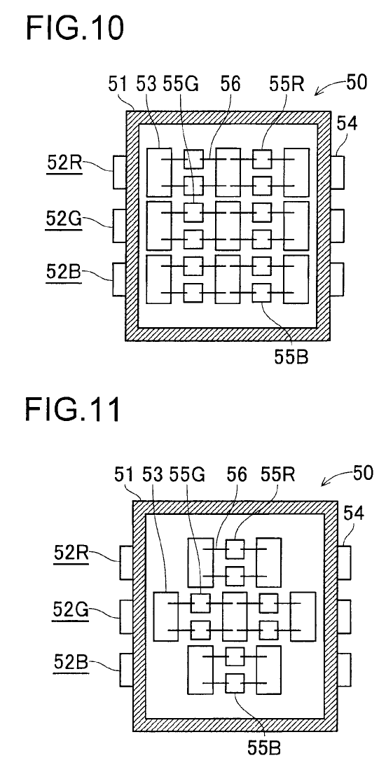

In this preferred embodiment, as shown in the diagram of FIG. 10 schematically showing the configuration of an LED package according to another aspect of this preferred embodiment, each of the light emission sections 52R, 52G and 52B may have three lead frames 53, two disposed at both ends of the frame 51 and the other disposed in the middle thereof inside the frame 51, terminals 54 connected to the lead frames 53 at both ends and four LED chips 55R, 55G or 55B; two LED chips 55R, 55G and 55B may be individually connected in parallel by wires 56 between the lead frames 53 at both ends and the lead frame 53 in the middle.

With this configuration, a larger number of LED chips 55 can be housed in the LED package 50. Thus, it is possible to obtain a larger amount of light emitted with respect to the size of the LED package 50.

As shown in the diagram of FIG. 11 schematically showing the configuration of an LED package according to another aspect of this preferred embodiment, the red (R) and blue (B) light emission sections 52R and 52B may have two lead frames 53 and two LED chips, and the green (G) light emission section 52G alone may have three lead frames 53, two disposed at both ends of the frame 51 and the other disposed in the middle thereof inside the frame 51 and four LED chips 55G. In this case, the LED chips 55G are also individually connected in parallel to the lead flames 53 by wires 56 on two-LED-chips-by-two-LED-chips basis.

With this configuration, it is possible to increase the brightness of green light without passing a high current to the low-brightness green (G) LED chips 55G as compared with the red (R) and blue (B) LED chips 55R and 55B. This allows easier adjustment of the balance (white balance) of white light emitted and results in improved durability of the green (G) LED chips 55G as compared with the two LED chips.

In this preferred embodiment, three or more LED chips connected in parallel may be used for each of LED chips 55R, 55G and 55B. In the light emission sections 52R, 52G and 52B, the LED chips 55R, 55G and 55B are preferably the same as each other. More preferably, as in the first and second preferred embodiments, the LED chips whose forward voltages Vf fall within the same grade are used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10: An LED package comprising:
a light emission section including two terminals and a plurality of LED chips connected to the terminals; wherein
the plurality of LED chips are connected in parallel between the terminals.

11: The LED package of claim 10, wherein the LED package comprises, as said light emission section, a plurality of light emission sections.

12: The LED package of claim 10, wherein at least one of the light emission sections includes a plurality of LED chip groups of the LED chips connected in parallel, and the plurality of LED chip groups are connected in series between the terminals.

13: The LED package of claim 10, wherein forward voltages of the plurality of LED chips in one of the light emission sections are within a same grade.

14: The LED package of claim 13, wherein when a same amount of current is passed through the plurality of LED chips whose forward voltages are within the same grade, a voltage difference therebetween is about 0.3 volts or less.

15: The LED package of claim 10, wherein the LED package comprises the light emission section including the LED chips emitting red light, the light emission section including the LED chips emitting green light and the light emission section including the LED chips emitting blue light.

16: The LED package of claim 15, wherein the LED chips emitting green light are greater in number than each of the LED chips emitting red light and the LED chips emitting blue light.

17: An illumination device comprising:
a light source section including a plurality of the LED package of claim 10 connected in series; and
a light guide plate transmitting light emitted from the light source section and radiating the light from an emission surface thereof.

18: A liquid crystal display device comprising:
a liquid crystal panel; and
the illumination device of claim 17 arranged to emit, from a back of the liquid crystal panel, the light radiated from the emission surface of the light guide plate.
